(19) United States
(12) Patent Application Publication
(10) Pub. No.: US 2016/0171533 A1
(43) Pub. Date: Jun. 16, 2016

(54) METHOD AND DEVICE FOR DISTRIBUTING INFORMATION TO A USER PROVIDED WITH A COMMUNICATING MOBILE TERMINAL WITH INFORMATION FILTERING AND LEARNING USING BIPARTITE GRAPHS OR NEURAL NETWORKS

(71) Applicant: TELLMEPLUS, Montpellier (FR)

(72) Inventor: JEAN-MICHEL CAMBOT, CLAPIERS (FR)

(21) Appl. No.: 14/436,861

(22) PCT Filed: Oct. 18, 2013
(86) PCT No.: PCT/FR2013/052499

§ 371 Date: Apr. 17, 2015

(30) Foreign Application Priority Data
Oct. 18, 2012 (FR) 1259963

(51) Int. Cl. G06Q 30/02; H04L 29/08

(52) U.S. Cl. CPC G06Q 30/0255; H04L 67/22; H04L 67/306; G06Q 30/0261

(57) ABSTRACT

A method for distributing information to a user equipped with a communicating mobile terminal. Geolocating the terminal to provide information representative of the geographical location of the terminal. The terminal communicates the information representative of the geographical location of the terminal to a server. The server selects stored information according to the information representative of the location of the terminal and predefined location data associated with each piece of information. The server filters the selected information according to a user profile associated with the terminal, sorts the filtered information by a bipartite graph, and transmits the sorted information to the terminal. The terminal displays the transmitted information on a screen. Determining the processing applied by the user to each displayed information according to an interaction of the user with the terminal. Learning, by the bipartite graph, according to the processing applied by the user to each displayed information.

### RELATED APPLICATION

This application is a §371 application from PCT/FR2013/052499 filed Oct. 18, 2013, which claims priority from French Patent Application No. 1259963 filed Oct. 18, 2012, each of which is herein incorporated by reference in its entirety.

### TECHNICAL FIELD OF THE INVENTION

The present invention concerns a method for distributing information to a user equipped with a communicating mobile terminal. It applies in particular to the distribution of promotional and commercial offers.

### BACKGROUND OF THE INVENTION

In the rest of this document, “geolocation” means a method of obtaining geographical coordinates of an object, for example based on triangulation between the antennas of a mobile telecommunications network or between earth-orbit satellites.

The costs of a promotional or advertising campaign for its issuer depend upon the amount of exposure it receives. But its effectiveness comes from its exposure to targets responsive to the subject of the promotional or advertising offer. Such constraints result in the need, for the issuers, to benefit from effective targeting of the recipients of their offers. Precise targeting simultaneously reduces the costs incurred by the promotional campaign and increases the probability of sparking the recipient's interest in the offer.

In some current systems, distribution of the offer is limited to targeting all users having a communicating mobile terminal and who are present around a geographical location. These systems do not make it possible to take the user's interest in the offer into account beyond merely being close to it.

In other current systems, the offer distribution, to users having a communicating mobile terminal, is limited to user profiles (defined in advance by users) deemed, by the issuer, to be the most likely to be interested in the content of the offer. These systems have the advantage of allowing much more precise targeting of the receivers based on information available in the profiles of users.

However, while the current systems, through their profiling techniques, make it possible to reduce the costs of a promotional or advertising campaign, their measurement of the effectiveness of the distribution is merely assumed. In addition, the only possible improvement in targeting for these systems is achieved by changing the information requested when each user profile is provided. Such an improvement is intrusive from the user's point of view since it requires some effort on his part.

The current technical means do not make it possible to respond in an optimized way to the constraints of:
optimized distribution of offers to users:
measuring a user's reaction to an offer; and
non-intrusively improving the targeting of user profiles.

### OBJECT AND SUMMARY OF THE INVENTION

The present invention aims to remedy all or part of these drawbacks.

To this end, the present invention envisages, according to a first aspect, a method for distributing information to a user equipped with a communicating mobile terminal.

The learning performed by the bipartite graph means that the profiling performed over all of the user profiles recorded can be further refined and thus enables targeting that becomes increasingly precise as the method is used more. In addition, such a method makes it possible to measure the relevance of a piece of information distributed, based on the processing applied by the user, and thus to measure the effectiveness of this piece of information with regard to the targeted profile. Lastly, these embodiments make it possible to limit distribution to user profiles of interest based on the piece of information to be distributed.

In some embodiments, each piece of information displayed during the display step is associated with spatial coordinates and displayed on a map based on spatial coordinates associated with this piece of information.

These embodiments have the advantage of allowing the user to benefit from greater visibility of the distribution in space of the information supplied to him. Greater visibility of the geographical location of a piece of information increases the probability that this piece of information will spark the user's interest.

In embodiments, each piece of information displayed during the display step is displayed in augmented reality on the screen of the communicating mobile terminal based on spatial coordinates associated with this piece of information.

Such embodiments make possible an ergonomic view of the location of information displayed around the user. In addition, these embodiments allow simplified access, for the user, to the defined location associated with the piece of information.

In some embodiments, the information selected during the selection step is limited to information whose associated spatial coordinates are located at a predefined maximum geographical distance from the geographical location transmitted in the communication step (210).

The advantage of these embodiments is that they make it possible for the user's communicating mobile terminal not to be swamped with information relating to sources geographically too distant from the user to spark his interest.

In some embodiments, the geolocation step supplies a piece of information representative of at least one place specified by the user and wherein the selection step is performed based on the piece of information representative of each place specified by the user.

These embodiments allow a user to view the information around a place, of interest to him, of his choice.

In some embodiments, the information selected during the selection step is limited to a predefined number whose associated spatial coordinates are located closest to the geographical coordinates transmitted in the communication step.

The advantage of these embodiments is that it makes it possible to distribute only the most relevant information to the user's communicating mobile terminal.

In some embodiments, the method that is the subject of the present invention comprises, upstream of the geolocation step, a step of the user defining his mood and for which the information stored by the server comprises a mood indicator associated with and used for performing the selection of information during the selection step.

These embodiments offer the advantage of allowing a more refined selection, with regard to the mood defined by the user, of information to be displayed for which the probability that it sparks interest in the user is increased.

In some embodiments, the method that is the subject of the present invention comprises, upstream of the geolocation step, a step of the user defining categories of information to be distributed and for which the information stored by the server comprises an indicator of category associated with and used for performing the selection of information during the selection step.

These embodiments offer the advantage of allowing a more refined selection of information to be displayed, based on the user's tastes, for which the probability that it sparks interest in the user is increased.

In some embodiments, the information displayed during the step of displaying, on a screen of the communicating mobile terminal, comprises an indicator of relevance determined according to the result of the bipartite graph's sorting of the piece of information.

These embodiments have the advantage of indicating to the user the probability that he will find this piece of information interesting.

In some embodiments, at least one piece of information selected, during the selection step, is selected based on a piece of weather-related data detected based on the piece of information representative of the terminal's location.

The advantage of these embodiments is that they allow a narrower selection of information based on weather conditions experienced by a user equipped with a communicating mobile terminal.

In some embodiments, at least one piece of information selected during the selection step is selected based on a timestamp detected based on the piece of information representative of the terminal's location.

These embodiments have the advantage of allowing a narrower selection of information based on time coordinates associated with the communicating mobile terminal.

In some embodiments, the predefined piece of timestamp data comprises a time of the day.

The advantage of these embodiments is that they make it possible to refine the information selection performed.

In some embodiments, the predefined piece of timestamp data comprises a day of the week.

The advantage of these embodiments is that they make it possible to refine the information selection performed.

In some embodiments, the predefined piece of timestamp data comprises a date of the year.

The advantage of these embodiments is that they make it possible to refine the information selection performed.

In some embodiments, the predefined piece of timestamp data comprises a universal celebration date.

The advantage of these embodiments is that they make it possible to refine the information selection performed.

In some embodiments, the predefined piece of timestamp data comprises a personal event calculated based on a recorded piece of personal data.

The advantage of these embodiments is that they make it possible to refine the information selection performed based on the user data.

The present invention envisages, according to a second aspect, a device for distributing information to a user equipped with a communicating mobile terminal.

As the particular features, advantages and aims of this device are similar to those of the method that is the subject of the present invention, they are not repeated here.

### BRIEF DESCRIPTION OF THE FIGURES

Other advantages, aims and features of the invention will become apparent from the description that follows of a particular embodiment of the method and the device for distributing information to a user equipped with a communicating mobile terminal, with reference to the drawings included in an appendix, in which:

FIG. 1 represents, in the form of a logical diagram, steps in a first particular embodiment of the method that is the subject of the present invention;

FIG. 2 represents, in the form of a logical diagram, steps in a second particular embodiment of the method that is the subject of the present invention;

FIG. 3 represents, in the form of a logical diagram, steps in a third particular embodiment of the method that is the subject of the present invention;

FIG. 4 represents, schematically, a particular embodiment of the device that is the subject of the present invention; and

FIG. 5 represents, schematically, a particular embodiment of a bipartite graph.

### DETAILED DESCRIPTION OF THE EMBODIMENTS

The present description is given as a non-limiting example.

As a reminder, a “bipartite graph” is, in graph theory, a graph in which all its vertices are divided into two subsets such that each edge has one end in each subset.

It is now noted that the figures are not to scale.

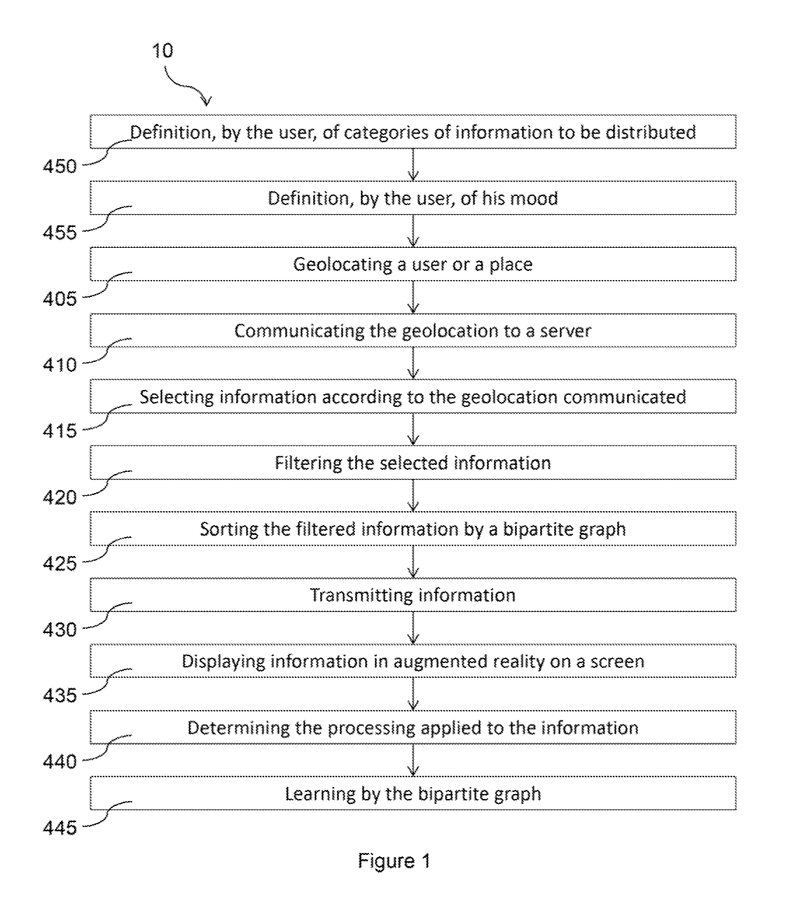

FIG. 1 shows a first particular embodiment of the method 10 that is the subject of the present invention. This method 10 comprises a step 450 of determining, by a user of the communicating mobile terminal, categories of information to be distributed on his terminal. These categories are selected, by the user, from amongst a drop-down list during the creation or editing the user profile of the terminal.

In these variants this user profile also comprises as information:
the user's home zip code;
the user's date of birth;
the user's electronic address; and
the user's gender.

This information is entered into memory and communicated to the server by the user filling in appropriate fields in a mobile application, incorporated into the communicating mobile terminal and/or via an Internet site.

In these variants, this method 10 also comprises a step 455 of determining, by a user of the communicating mobile terminal, his mood. This mood is selected, by the user, from amongst a list of moods proposed on opening a mobile application serving to display information distributed by the method that is the subject of the present invention.

This method 10 also comprises a step 405 of geolocating the communicating mobile terminal by activating a collector of geographical data incorporated into the terminal or of a place designated on a map by retrieving on the Internet geographical coordinates of the place indicated by the user and storing the piece of information thus collected on the terminal. Such data comprise the longitude, latitude and altitude of the communicating mobile terminal or designated place. This geolocation step 405 can also utilize the coordinates of a relay antenna connected to the communicating mobile terminal.

This method 10 also comprises a step 410 of communicating, by the communicating mobile terminal, the piece of information representative of the geographic location stored previously and also, in variants, an indicator of the mood defined by the user. This communication step 410 is achieved by actuating an antenna, operating for a wireless Internet network and for a data network incorporated into a network of mobile telephony, and the transmission of the stored piece of geolocation information. In variants, this communication step 410 performs the transmission of the defined mood indicator to a remote server by a telecommunications network such as, for example, the Internet.

This method 10 comprises, next, a step 415 of selecting at least one piece of information, stored by the server, according to the information representative of the location of the terminal communicated, and:
predefined location data associated with each piece of information;
a piece of weather-related data associated with this information; and
a timestamp associated with this information.

The piece of data related to weather close to the geographical coordinates of the communicating mobile terminal is obtained by the server issuing a request for meteorological environment information to another remote server.

The piece of weather-related information makes it possible, for example, to select a commercial offer when it is raining at the geographical coordinates of the communicating mobile terminal.

The timestamp is obtained by reading a packet, from the latest message communicated by the communicating mobile terminal, comprising timestamp data for the issuing of the message. In variants, the timestamp is obtained by the server issuing a request to another remote server in order to obtain the time and date at the geographical coordinates of the communicating mobile terminal.

The timestamp associated with a piece of information comprises, for example, a time of the day, a day of the week and/or the closeness of a universal celebration such as, for example, December 24, or a personal celebration, such as the user's birthday.

This information stored by the server can be promotional offers available in a specific store and comprising, as well as a set of text and images describing the nature of the promotion, the address or geographical coordinates of the store where such a promotion is taking place.

In variants, this stored information comprises a set of associated characteristics defined during the creation of the information, such as for example:
the gender of the users;
the mood indicator associated with the information;
the category of the information; and
the age of the users targeted by such a piece of information.

Memorization of such information is achieved by populating a database located on the server. In such a step 415, a computer program on the server compares, for each piece of information stored, the geographical coordinates associated with this information (such as the location of the store where a promotion is taking place) to the geographical coordinates sent by the communicating mobile terminal, and selects a predefined maximum number of pieces of stored information whose coordinates are closest to the geographical coordinates received and less than a predefined maximum distance.

This method 10 comprises a step 420 of filtering selected information according to a profile of the user of the communicating mobile terminal. This user profile comprises as information:
the user's date of birth; and
the user's gender.

This information is entered into memory and communicated to the server by the user filling in appropriate fields in a mobile application, incorporated into the communicating mobile terminal and/or via an Internet site. The user's mood field is received by the server. This filtering step 420 is performed by a computer program on the server, which compares the communicating mobile terminal's user profile to the characteristics of the stored information and selects the stored information whose characteristics correspond to the information supplied by the user profile.

In variants, the filtering step 420 filters the selected information based on at least one piece of information from amongst:
the user's electronic address;
the user's mood; and
the user's zip code.

In particular, the zip code information is used when a geolocation step is not performed.

This method 10 also comprises a step 425 of sorting the filtered information by a bipartite graph. In this sorting step 425, the bipartite graph bases its sort on an analysis of the history of the processing carried out, by the user, with regard to information displayed previously on his communicating mobile terminal. The processing thus analyzed by the bipartite graph comprises:
the purchases made by the user;
the sharing of information by the user;
the ratings assigned to each place by the user:
the ratings assigned to each piece of information by the user;
the deletion of information by the user; and
the processing carried out by users having similar profiles to that of the current user

based on information comprising similar characteristics to the information analyzed by the bipartite graph. Each behavior analyzed is incorporated into a calculation formula whose result serves as the basis for sorting filtered information. For example, if a previously displayed commercial offer has led to a purchase and one of the filtered offers has similar characteristics, the filtered offer will be placed higher in the list than another that does not have any common characteristic even though it also resulted in a purchase.

With regard to databases employed, for example, the use of a bipartite graph makes it possible to optimize the calculation speed. In the bipartite graph used, a first group of vertices represents each user and a second group of vertices represents products comprising spatial and temporal data. For example, a commercial offer is limited in time and to a geographic area.

In this bipartite graph, an arc between a user and a commercial offer represents processing performed by the user with regard to a commercial offer. A similarity between commercial offers, generating a so-called “semantic” recommendation, is symbolized by an arc between the vertices representing these offers. A similarity between commercial offers based on the processing performed by users with regard to a piece of information is represented by an arc between the vertices representative of these users.

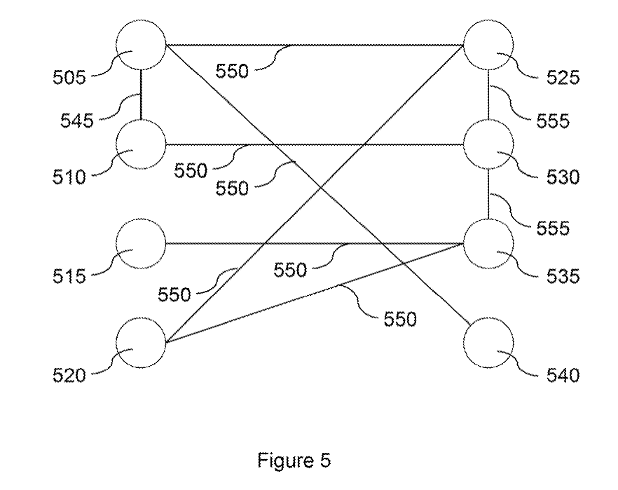

FIG. 5 shows a particular example of a bipartite graph as used in the sorting step 425. In this bipartite graph, vertices 505, 510, 515 and 520, on the left, represent users, and vertices 525, 530, 535 and 540, on the right, represent commercial offers. The arc 545 linking the user 505 to another user 510 represents a relationship link between the two users, 505 and 510. Such a link can be obtained, for example, by obtaining data from a social network allowing a link to be established between the two users, 505 and 510. The arcs 550 represent processing performed by a user, 505, 510, 515 and 520, with regard to a commercial offer, 525, 530, 535 and 540. In this example; it is considered that each processing performed has been favorable to the offer suggested, but in other cases this processing can be a refusal of the offer. The arcs 555 represent similarities between characteristics of the two offers. Such characteristics can be, e.g., a preferred timestamp for the distribution of the offer, a common product or a weather-related environment, for example.

In this example, the case is considered in particular of the user 510 who connects to a website using the method described in FIG. 1 and who performs positive processing 550 with regard to a commercial offer 530. During the selection step 415, the server selects, for example, ten offers of which six, not shown, are filtered during the filtering step 420 since they do not match the commercial offers that the user 510 wishes to receive.

Among the remaining four commercial offers, 525, 530, 535 and 540, commercial offers 530 and 525 have some similarities of characteristics whereas commercial offers 530 and 535 have other, or the same, similarities of characteristics. Commercial offer 540 has no similarity of characteristics with the other commercial offers, 525, 530 and 535, except that of having geographical coordinates close to the coordinates transmitted by the communicating mobile terminal of the user 510.

The bipartite graph, having stored the processing 550 performed by the user 510 with regard to the commercial offer 530 compares the number of arcs touching each of the other commercial offers, 525, 535 and 540. During the sort step 425, the server scans this bipartite graph and discovers that:
commercial offer 525 is touched by three arcs;
commercial offer 535 is touched by three arcs; and
commercial offer 540 is touched by one arc.

Offer 540 is therefore placed last in the sort performed. Commercial offer 525 having one of its arcs coming from a user 505 having a relationship 545 with the target user 510, offer 525 is considered more relevant with regard to the user 510. Consequently, the sort step 524 places commercial offer 525 in first place, followed by commercial offer 535 and finally by commercial offer 540.

Each arc can be weighted based on a predefined degree of relevance.

This method 10 also comprises a step 430 of transmitting the sorted information from the server to the communicating mobile terminal by means of a telecommunications network (e.g. the Internet).

This method 10 comprises a step 435 of displaying sorted information, displayed based on the user's choice from amongst a list:
in a list according to the order defined in the sort step 425;
geolocated on a map; or
in augmented reality and geolocated

on a screen of the communicating mobile terminal, together with an indicator of relevance associated with each piece of information displayed (e.g. in the form of a number of hearts next to the title of the piece of information).

The method 10 also comprises a step 440 of determining the processing applied by the user to each piece of displayed information according to an interaction of the user with the terminal. Such processing is detailed above and corresponds to processing analyzed by the bipartite graph. The user's interactions with the terminal can take the form of:
pressing on a screen;
pressing a button;
contact with a screen (e.g. with a stylus); or
a voice command.

The method 10 comprises, lastly, a step 445 of learning, by the bipartite graph, according to the processing applied by the user to each piece of displayed information. This learning is a set of programmed methods making the analysis and the behaviors of the bipartite graph evolve based on empirical data that the processing applied by the user to each piece of displayed information constitutes.

In variants of the definition step 455, the mood can include the user's desire of the moment, represented by the choice from amongst a drop-down list of categories, as defined in the determination step 450, to be distributed independently of the categories selected during the determination step 450. In these variants, the categories selected in this way replace the categories selected during the determination step 450 or perform an additional selection.

In some variants of the display step 435, a portion, e.g. a predefined number, of the sorted information is displayed, not all the sorted information. In these variants, during the display step 435, the user can display this same predefined number of pieces of information that he wants by utilizing a function searching for key-words in the title, the information content, the store name, the associated brand and the information category. This search is performed by filling in a field on the communicating mobile terminal and via a computer search program. The results are then displayed in order of their indicator of relevance.

In other variants, the user can, at any time in the display step 435, display aids (textual, auditory and/or graphical) relating to the content displayed at that moment. In these variants, this display is dependent upon an interaction by the user with the communicating mobile terminal (e.g. a deliberate shake of the terminal, pressing a button, pressing on a screen; contact with a screen and/or a voice command).

In some variants of the step 440 of determining the processing applied by the user to each piece of information displayed, the piece of information displayed is saved on the communicating mobile terminal based on the processing applied by the user. In such variants, only the processing representing the user's interest in the information leads to saving on the communicating mobile terminal. In some variants, the saved piece of information is displayed when the communicating mobile terminal is located geographically close to the coordinates associated with this piece of information.

Here is an example of using the method 10 seen in FIG. 1:

The method makes it possible to detect, by semantic analysis of the offer, when an offer has received a certain reaction:
within a specific population, this population being identified by a pair of pieces of information: “gender” and “age”;
in a local context, such as a country or a region, for example;
in a specific weather-related environment, such as rainy or sunny, or a temperature; and/or
at a certain period, e.g. at the beginning of the week, during vacations, end of the year, morning or evening.

The reproduction of all or part of this environment forms a context of similarity that is going to strengthen the other similarity criteria for profiles of other commercial offers recorded.

This method therefore uses a step of “capturing” behaviors by means of the communicating mobile terminal, which makes it possible to obtain, first of all, the geolocation, and therefore the surrounding weather-related environment, of a user by identifying the communicating mobile terminal via a profile number.

If this profile is not known, during a first connection, the commercial offer suggestions are sent to the communicating mobile terminal based solely on a general context, such as the weather-related environment surrounding the communicating mobile terminal and the desires of the moment of a community in a given place, and, if the age and gender information of the communicating mobile terminal's user are known, for an age range and a specific gender.

If the profile is recognized, using the bipartite graph that learned the user's last actions allows very relevant commercial offers to be suggested, even with very little data supplied voluntarily by the user.

The profile receives the commercial offers and reacts or does not react, e.g. by rejecting, selecting, noting, sharing or going to the commercial offer, or by purchasing an object of this offer. This reaction, or absence of reaction, drives an engine that analyzes and interprets the reaction, making it possible to learn the tastes associated with this profile of the bipartite graph.

All the behaviors of each user via the communicating mobile terminal enrich the bipartite graph's knowledge of the profile's tastes and are associated each time with a context comprising geolocation, timestamp and weather-related environment data.
For example, a 39-year-old woman launches the application with her smartphone one Monday during the summer vacation, in Florida and in good weather. This woman has possibly already received recommendations made by the application and has reacted.

In this specific context, the bipartite graph has learned that this is the ideal time to propose anti-wrinkle cosmetics with a sunscreen to this specific target, who is interested in this type of recommendation, especially on Monday mornings when 46% of women feel least attractive, according to processing carried out for offers proposed previously. If the woman had launched the application on a Thursday, another, more daring, commercial offer would have been proposed, because the bipartite graph had learned that on Thursday this target, in contrast, feels better about herself according to processing carried out for offers proposed previously.
Such a method makes it possible to perform profiling to produce recommendations that are better targeted and relevant, and therefore better accepted. These recommendations are therefore displayed on the communicating mobile terminal, possibly in augmented reality, then a form of dialog is established, an analysis of the behavior in reaction to these recommendations, which will enrich the knowledge of the profile, and benefit the entire community.

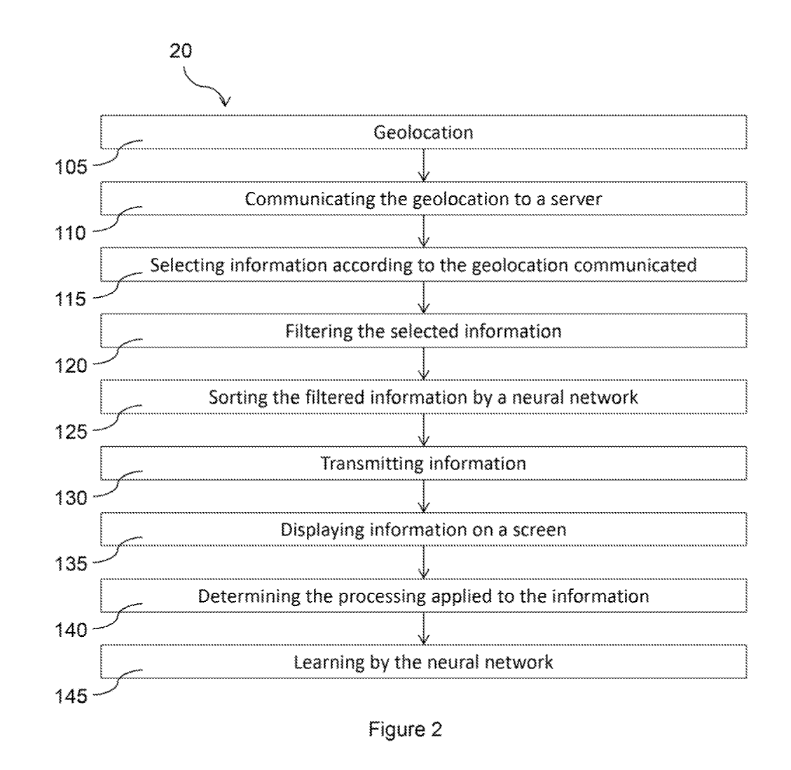

FIG. 2 shows a second particular embodiment of the method 20 that is the subject of the present invention. This method 20 also comprises a step 105 of geolocating the communicating mobile terminal by activating a collector of geographical data incorporated into the terminal and storing the piece of information thus collected on the terminal. Such data comprise the longitude, latitude and altitude of the communicating mobile terminal.

This method 20 also comprises a step 110 of communicating, by the communicating mobile terminal, the piece of information representative of the terminal's geographic location stored previously. This communication step 110 is achieved by actuating an antenna (operating for a wireless Internet network and for a data network incorporated into a network of mobile telephony) and the transmission of the stored piece of geolocation information to a remote server by a telecommunications network such as, for example, the Internet.

This method 20 comprises, next, a step 115 of selecting at least one piece of information, stored by the server, according to the information representative of the location of the terminal communicated, and location data associated with each piece of information. This information stored by the server can be promotional offers available in a specific store and comprising, as well as a set of text and images describing the nature of the promotion, the address or geographical coordinates of the store where such a promotion is taking place. In addition, this stored information comprises a set of associated characteristics defined during the creation of the information, such as for example:
the gender of the users; and
the age of the users targeted by such a piece of information.

Memorization of such information is achieved by populating a database located on the server. In such a step 115, a computer program on the server compares, for each piece of information stored, the geographical coordinates associated with this information (such as the location of the store where a promotion is taking place) to the geographical coordinates received from the communicating mobile terminal, and selects the pieces of stored information whose coordinates are closest to the geographical coordinates received.

This method 20 comprises a step 120 of filtering selected information according to a profile of the user of the communicating mobile terminal. This user profile comprises as information:
the user's date of birth; and
the user's gender.

This information is entered into memory and communicated to the server by the user filling in appropriate fields in a mobile application, incorporated into the communicating mobile terminal and/or via an Internet site. This filtering step 120 is performed by a computer program on the server, which compares the communicating mobile terminal's user profile to the characteristics of the stored information and selects the stored information whose characteristics correspond to the information supplied by the user profile.

In variants, the filtering step 120 filters the selected information based on at least one piece of information from amongst:
the user's electronic address;
the user's mood; and
the user's zip code.

This method 20 also comprises a step 125 of sorting the filtered information by a neural network. A neural network (or artificial neural network) is a programmed computation model that can be optimized by probabilistic learning methods. These learning methods, also programmed, allow the neural network to adapt its analyses and behavior based on empirical data. In this sorting step 125, the neural network bases its sort on an analysis of the history of the processing carried out, by the user, of information displayed previously on his communicating mobile terminal. The processing thus analyzed by the neural network comprises:
the purchases made by the user;
the sharing of information by the user;
the ratings assigned to each place by the user:
the ratings assigned to each piece of information by the user;
the deletion of information by the user; and
the processing carried out by users having similar profiles to that of the current user

based on information comprising similar characteristics to the information analyzed by the neural network. Each behavior analyzed is incorporated into a calculation formula whose result serves as the basis for sorting filtered information. For example, if a previously displayed commercial offer has led to a purchase and one of the filtered offers has similar characteristics, the filtered offer will be placed higher in the list than another that does not have any common characteristic even though it also resulted in a purchase.

This method 20 also comprises a step 130 of transmitting the sorted information from the server to the communicating mobile terminal by means of a telecommunications network (e.g. the Internet).

This method 20 comprises a step 135 of displaying on a screen of the communicating mobile terminal, in a list according to the order defined in the sort step 125, information sorted and transmitted during the transmission step 130.

The method 20 also comprises a step 140 of determining the processing applied by the user to each piece of displayed information according to an interaction of the user with the terminal. Such processing is detailed above and corresponds to processing analyzed by the neural network. The user's interactions with the terminal can take the form of:
pressing on a screen;
pressing a button;
contact with a screen (e.g. with a stylus); or
a voice command.

The method 20 comprises, lastly, a step 145 of learning, by the neural network, according to the processing applied by the user to each piece of displayed information. This learning is a set of programmed methods making the analysis and the behaviors of the neural network evolve based on empirical data that the processing applied by the user to each piece of displayed information constitutes.

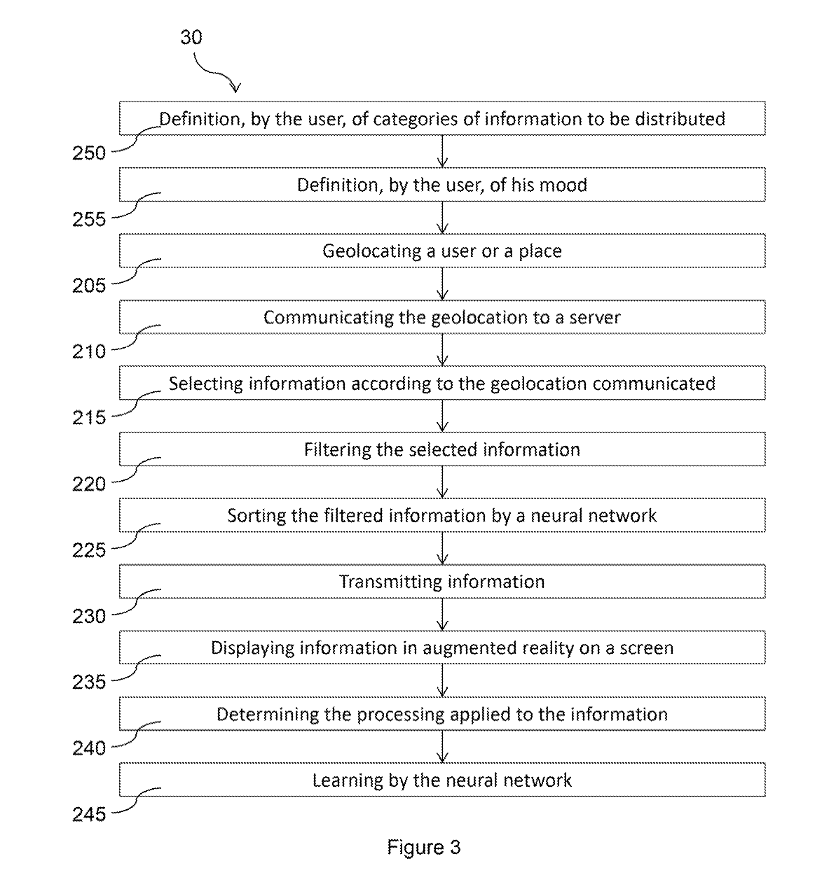

FIG. 3 shows a third particular embodiment of the method 30 that is the subject of the present invention. This method 30 comprises a step 250 of determining, by a user of the communicating mobile terminal, categories of information to be distributed on his terminal. These categories are selected, by the user, from amongst a drop-down list during the creation or editing the user profile of the terminal. This user profile also comprises as information:
the user's home zip code;
the user's date of birth;
the user's electronic address; and
the user's gender.

This information is entered into memory and communicated to the server by the user filling in appropriate fields in a mobile application, incorporated into the communicating mobile terminal and/or via an Internet site.

In these variants, this method 30 also comprises a step 255 of determining, by a user of the communicating mobile terminal, his mood. This mood is selected, by the user, from amongst a list of moods proposed on opening a mobile application serving to display information distributed by the method that is the subject of the present invention. This method 30 also comprises a step 205 of geolocating the communicating mobile terminal by activating a collector of geographical data incorporated into the terminal or of a place designated on a map by retrieving on the Internet geographical coordinates of the place indicated by the user and storing the piece of information thus collected on the terminal. Such data comprise the longitude, latitude and altitude of the communicating mobile terminal or designated place.

This method 30 also comprises a step 210 of communicating, by the communicating mobile terminal, the piece of information representative of the geographic location stored previously and also an indicator of the mood defined by the user. This communication step 210 is achieved by actuating an antenna (operating for a wireless Internet network and for a data network incorporated into a network of mobile telephony) and the transmission of the stored piece of geolocation information and the indicator of the mood defined to a remote server by a telecommunications network such as, for example, the Internet.

This method 30 comprises, next, a step 215 of selecting at least one piece of information, stored by the server, according to the information representative of the location communicated and predefined location data associated with each piece of information. This information stored by the server can be promotional offers available in a specific store and comprising, as well as a set of text and images describing the nature of the promotion, the address or geographical coordinates of the store where such a promotion is taking place. In addition, this stored information comprises a set of associated characteristics defined during the creation of the information, such as for example:
the gender of the users; and
the mood indicator associated with the information;
the category of the information;
the age of the users targeted by such a piece of information;
a piece of weather-related data associated with this information; and
a timestamp associated with this information.

The piece of data related to weather close to the geographical coordinates of the communicating mobile terminal is obtained by the server issuing a request for meteorological environment information to another remote server.

The piece of weather-related information makes it possible, for example, to select a commercial offer when it is raining at the geographical coordinates of the communicating mobile terminal.

The timestamp is obtained by reading a packet, from the latest message communicated by the communicating mobile terminal, comprising timestamp data for the issuing of the message. In variants, the timestamp is obtained by the server issuing a request to another remote server in order to obtain the time and date at the geographical coordinates of the communicating mobile terminal.

The timestamp associated with a piece of information comprises, for example, a time of the day, a day of the week and/or the closeness of a universal celebration such as, for example, December 24, or a personal celebration, such as the user's birthday.

Memorization of such information is achieved by populating a database located on the server. In such a step 215, a computer program on the server compares, for each piece of information stored, the geographical coordinates associated with this information (such as the location of the store where a promotion is taking place) to the geographical coordinates sent by the communicating mobile terminal, and selects a predefined maximum number of pieces of stored information whose coordinates are closest to the geographical coordinates received and less than a predefined maximum distance.

This method 30 comprises a step 220 of filtering selected information according to a profile of the user of the communicating mobile terminal. This user profile comprises as information:
the user's date of birth; and
the user's gender.

This information is entered into memory and communicated to the server by the user filling in appropriate fields in a mobile application, incorporated into the communicating mobile terminal and/or via an Internet site. The user's mood field is received by the server. This filtering step 220 is performed by a computer program on the server, which compares the communicating mobile terminal's user profile to the characteristics of the stored information and selects the stored information whose characteristics correspond to the information supplied by the user profile.

In variants, the filtering step 220 filters the selected information based on at least one piece of information from amongst:
the user's electronic address;
the user's mood; and
the user's zip code.

This method 30 also comprises a step 225 of sorting the filtered information by a neural network. In this sorting step 225, the neural network bases its sort on an analysis of the history of the processing carried out, by the user, of information displayed previously on his communicating mobile terminal. The processing thus analyzed by the neural network comprises:
the purchases made by the user;
the sharing of information by the user;
the ratings assigned to each place by the user:
the ratings assigned to each piece of information by the user;
the deletion of information by the user; and
the processing carried out by users having similar profiles to that of the current user

based on information comprising similar characteristics to the information analyzed by the neural network. Each behavior analyzed is incorporated into a calculation formula whose result serves as the basis for sorting filtered information. For example, if a previously displayed commercial offer has led to a purchase and one of the filtered offers has similar characteristics, the filtered offer will be placed higher in the list than another that does not have any common characteristic even though it also resulted in a purchase.

This method 30 also comprises a step 230 of transmitting the sorted information from the server to the communicating mobile terminal by means of a telecommunications network (e.g. the Internet).

This method 30 comprises a step 235 of displaying sorted information, displayed based on the user's choice from amongst a list:
in a list according to the order defined in the sort step 225;
geolocated on a map; or
in augmented reality and geolocated

on a screen of the communicating mobile terminal, together with an indicator of relevance associated with each piece of information displayed (e.g. in the form of a number of hearts next to the title of the piece of information).

The method 30 also comprises a step 240 of determining the processing applied by the user to each piece of displayed information according to an interaction of the user with the terminal. Such processing is detailed above and corresponds to processing analyzed by the neural network. The user's interactions with the terminal can take the form of:
pressing on a screen;
pressing a button;
contact with a screen (e.g. with a stylus); or
a voice command.

The method 30 comprises, lastly, a step 245 of learning, by the neural network, according to the processing applied by the user to each piece of displayed information. This learning is a set of programmed methods making the analysis and the behaviors of the neural network evolve based on empirical data that the processing applied by the user to each piece of displayed information constitutes.

In variants of the definition step 255, the mood can include the user's desire of the moment, represented by the choice from amongst a drop-down list of categories, as defined in the determination step 250, to be distributed independently of the categories selected during the determination step 250. In these variants, the categories selected in this way replace the categories selected during the determination step 250 or perform an additional selection.

In some variants of the display step 235, a portion, e.g. a predefined number, of the sorted information is displayed, not all the sorted information. In these variants, during the display step 235, the user can display this same predefined number of pieces of information that he wants by utilizing a function searching for key-words in the title, the information content, the store name, the associated brand and the information category. This search is performed by filling in a field on the communicating mobile terminal and via a computer search program. The results are then displayed in order of their indicator of relevance.

In other variants, the user can, at any time in the display step 235, display aids (textual, auditory and/or graphical) relating to the content displayed at that moment. In these variants, this display is dependent upon an interaction by the user with the communicating mobile terminal (e.g. a deliberate shake of the terminal, pressing a button, pressing on a screen; contact with a screen and/or a voice command).

In some variants of the step 240 of determining the processing applied by the user to each piece of information displayed, the piece of information displayed is saved on the communicating mobile terminal based on the processing applied by the user. In such variants, only the processing representing the user's interest in the information leads to saving on the communicating mobile terminal. In some variants, the saved piece of information is displayed when the communicating mobile terminal is located geographically close to the coordinates associated with this piece of information.

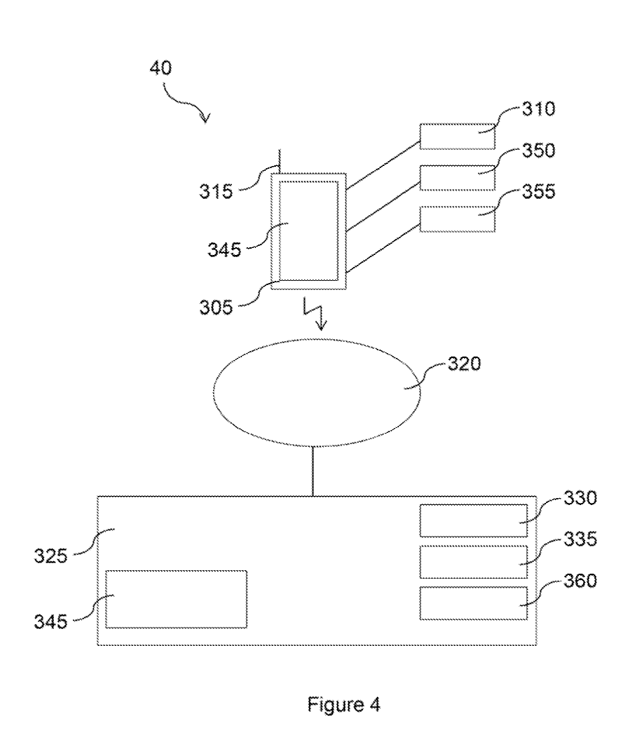

FIG. 4 shows a particular embodiment of the device 40 that is the subject of the present invention. This device 40 comprises a communicating mobile terminal 305 comprising a means 310 of geolocating the terminal 305, where this means 305 may take the form of a collector of geographical data such as, for example, a GPS chip and its associated controller. The communicating mobile terminal 305 also comprises a means 350 of determining the processing applied by the user to each piece of displayed information according to an interaction of the user with the terminal 305. This means 350 taking the form of an application capturing the user's interactions with the terminal 305. This communicating mobile terminal 305 comprises, in addition, a means of display 355 (such as a screen controller) on a screen 345 of the communicating mobile terminal 305. Lastly, this communicating mobile terminal 305 comprises a means 315 of communication (a wireless Internet antenna or an antenna of a data network of a mobile telephony network) by the communicating mobile terminal 305 to a server 325 accessible by a telecommunications network 320 such as, for example, the Internet.

This device 40 also comprises a server 325, which comprises a main memory, a program memory and a controller. This server 235 also comprises a means 330 of selecting (e.g. a program) at least one piece of information stored in a database according to the information representative of the location of the terminal 305 and predefined location data associated with each piece of information. In addition, this server 325 comprises a means 360 of filtering, also in the form of a computer program, of each piece of information selected based on a profile of the user of the communicating mobile terminal 305. Lastly, this server 325 comprises a neural network or bipartite graph 345 configured to sort the filtered information and a means 335 transmitting the sorted information to the communicating mobile terminal, such as a wired connection to the Internet network and a controller associated with such a network.

1-17. (canceled)

18. Method for distributing information to a user equipped with a communicating mobile terminal, comprising the steps of:
geolocating the communicating mobile terminal to provide a piece of information representative of a geographical location of the communicating mobile terminal;
communicating, by the communicating mobile terminal, to a server accessible by a telecommunications network, information representative of the geographical location of the communicating mobile terminal;
selecting at least one piece of stored information, by the server, according to the information representative of the location of the communicating mobile terminal and a predefined location data associated with each piece of selected information;
filtering each piece of selected information according to a profile of the user of the communicating mobile terminal;
sorting filtered information by a bipartite graph;
transmitting the sorted information to the communicating mobile terminal by the server;
displaying, on a screen of the communicating mobile terminal, at least one piece of transmitted information;
determining a processing applied by the user to each piece of displayed information according to an interaction of the user with the communicating mobile terminal; and
learning, by the bipartite graph, according to the processing applied by the user to each piece of displayed information.

19. Method according to claim 18, wherein each piece of information displayed during the display step is associated with spatial coordinates and displayed on a map based on spatial coordinates associated with said each piece of displayed information.

20. Method according to claim 18, further comprising the step of displaying each piece of information in augmented reality on the screen of the communicating mobile terminal based on spatial coordinates associated with said each piece of displayed information.

21. Method according to claim 18, wherein the step of selecting said at least one piece of stored information limits selection to information whose associated spatial coordinates are located at a predefined maximum geographical distance from the geographical location of the communicating mobile terminal.

22. Method according to claim 18, wherein the step of geolocating provides a piece of information representative of at least one place specified by the user; and wherein the step of selecting selects said at least one piece of stored information based on the piece of information representative of each place specified by the user.

23. Method according to claim 18, wherein the step of selecting said at least one piece of stored information limits selection to a predefined number whose associated spatial coordinates are located closest to the geographical location of the communicating mobile terminal.

24. Method according to claim 18, further comprising the steps of defining a mood by the user; and storing a mood indicator in accordance with the mood defined by the user as a piece of the stored information by the server.

25. Method according to claim 18, further comprising the steps of defining categories of information to be distributed by the user; and storing category indicators in accordance with categories of information defined by the user as pieces of the stored information by the server.

26. Method according to claim 18, further comprising the step of displaying an indicator of relevance determined in accordance with the sorted information on the screen of the communicating mobile terminal.

27. Method according to claim 18, wherein the step of selecting said at least one piece of stored information selects based on a piece of weather-related data determined in accordance with the information representative of the geographical location of the communicating mobile terminal.

28. Method according to claim 18, wherein the step of selecting said at least one piece of stored information selects based on a timestamp data determined in accordance with the information representative of the geographical location of the communicating mobile terminal.

29. Method according to claim 28, wherein a predefined piece of the timestamp data comprises a time of a day.

30. Method according to claim 28, wherein a predefined piece of the timestamp data comprises a day of a week.

31. Method according to claim 28, wherein a predefined piece of the timestamp data comprises a date of a year.

32. Method according to claim 28, wherein a predefined piece of the timestamp data comprises a universal celebration date.

33. Method according to claim 28, wherein a predefined piece of the timestamp data comprises a personal event determined based on a recorded piece of personal data.

34. Device for distributing information to a user equipped with a communicating mobile terminal, comprising:
a geolocator to geolocate the communicating mobile terminal and configured to provide a piece of information representative of a geographical location of the communicating mobile terminal;
a communications module to communicate the information representative of the geographical location of the communicating mobile terminal to a server accessible by a telecommunications network by the communicating mobile terminal;
the server comprising:
a selector to select at least one piece of stored information according to the information representative of the geographical location of the communicating mobile terminal and a predefined location data associated with each piece of the selected information;
a filter to filter said each piece of selected information according to a profile of the user of the communicating mobile terminal;
a bipartite graph configured to sort the filtered information; and
a transmitter to transmit the sorted information to the communicating mobile terminal to be displayed on a screen of the communicating mobile terminal;
a processing module to determine a processing applied by the user to each piece of displayed information according to an interaction of the user with the communicating mobile terminal; and
wherein the bipartite graph is configured to perform learning according to the processing applied by the user to said each piece of displayed information.
